(19) United States
(12) Patent Application Publication
(10) Pub. No.: US 2003/0084331 A1
(43) Pub. Date: May 1, 2003

(54) Method for providing user authentication/authorization and distributed firewall utilizing same

(75) Inventors: William H. Dixon, Seattle, WA (US); Gurdeep S. Pall, Sammamish, WA (US); Ashwin Palekar, Sammamish, WA (US); Bernard D. Aboba, Bellevue, WA (US); Brian D. Swander, Bellevue, WA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Microsoft Corporation, Redmond, WA (US)

(21) Appl. No.: 10/014,747

(22) Filed: Oct. 26, 2001

(51) Int. Cl. H04L 9/00

(52) U.S. Cl. 713/200; 713/153

(57) ABSTRACT

The distributed firewall performs user authentication at a first level to establish a user security context for traffic from that user, and an authority context provides authorization for subsequent traffic. This authority context may be based on an underlying policy for particular types of traffic, access to particular applications, etc. Additionally, the system includes the ability to allow a user/process/application to define its own access control. The linking of the user security context from the traffic to the application is accomplished by enabling IPSec on a socket and forcing the socket to be bound in exclusive mode. The most common policy definitions may be included by default. Extensions of the Internet key exchange protocol (IKE) to provide the desired user authentication plus application/purpose are also provided. The architecture includes pluggable authorization module(s) that are called after IKE has successfully authenticated the peer, but before the connection is allowed to complete.

### FIELD OF THE INVENTION

This invention relates generally to network firewall systems and, more particularly, to distributed firewall systems providing end point protection at each peer/server.

### BACKGROUND OF THE INVENTION

Firewalls today are building highly sophisticated network protocol stacks for protocol and content analysis. Unfortunately, inspection points in the middle of the network are a choke point. That is to say, they do not enable communications to scale because they necessarily slow down end-to-end communication in order to inspect packets. At 100 Mbit, 1 Gbit, and 10 gigabit speeds, no single point can afford to do anything but route traffic into the destination network which spreads this aggregated load along successively smaller paths to reach end-systems. Such a prior architecture is illustrated in FIG. 7. As may be seen from this simplified environmental diagram, a private network 700 includes a plurality of end system computers 702, 704, 706. This private network 700 also includes an intermediately deployed firewall 708 that serves to protect the private network 700 from the public network 710. Other private networks 712 also including a plurality of end systems 714, 716, 718 are also protected from the public network 710 by a firewall 720.

Network traffic analysis is usually defined by the features of the role of the device doing the inspection. Firewall functions typically permit, deny, statefully allow, and audit traffic. Traffic modification may also be done, e.g. NAT, URL substitution. Further, traffic analysis may be done separately for intrusion detection, e.g. virus scanning). It may also be done separately to enforce quality of service (QOS). When all of these functions are viewed along the path from end-to-end, the packet inspection being conducted is on the order of an arbitrary program operating at each protocol layer.

When the analysis tasks become more complex than what can be accomplished in protocols, application gateways and/or proxies become the logical end. In these application gateways and proxies, fully programmed operations can be accomplished based on the very nature of what is being communicated itself. This creates significant barriers for end-system communications to evolve quickly by requiring or utilizing multi-tier application architectures that move further away from true end-to-end communication. The multiple middle points, which are each fixed in their individual functionality, result in an overall system that results in very complex and costly management of the many independent systems. Weaknesses in all of these require constant update and monitoring.

Businesses deployed firewalls 708, 720 several years ago because their internal end-systems 702, 704, 706, 714, 716, 718 were dreadfully insecure against anonymous network access. Prior to such deployment, every application using the network was required to implement it's own security. Many of these applications did not do a good job, were shipped with insecure defaults, or could easily be made insecure by accident. To overcome these individual application security problems, the network firewall 708, 720 was deployed as a barrier between the perceived hostile public network 710 and the private network 700, 712 of the business, sacrificing scaleability for security.

Despite the early security concerns that led to the deployment of the network firewall, today millions of end system personal computers (PCs) 722, 724 directly connect to the Internet and remain on all the time, regardless of the threat of network attack. Some have installed third party personal firewalls, and some have their Internet service providers (ISPs) performing network intrusion detection and content filtering for them. Further, data has revealed that the public network may not be the only hostile environment from which end system machines must be protected. Indeed, it appears that network users within the private network itself perpetrate many network attacks. These malicious, disgruntled, or simply dishonest employees or users of the network often cause many more problems than foreign attacks.

To overcome the network scaling and speed problem caused by the network firewall deployment while providing the required security for the end system computers, distributed firewalls running on each end system computer have been proposed. The intent of these distributed firewall proposals is to have the end-host system provide equivalent functionality as firewalls do today as intermediate network devices. This allows the network to concentrate on delivering packets to and from end-systems as fast as possible. The currently deployed network firewalls then may evolve to become IP gateways. These network firewalls may still be a focal point through which all traffic flows, but may now allow it to flow freely by limiting the functions that they are required to perform.

These limited functions include rate-limiting traffic to ensure that traffic does not enter the network faster than it can be consumed. Access control may also be performed to provide authenticated traversal. That is, some systems that wish to send traffic into the network may have to authenticate to the gateway first before sending traffic. The type of traffic sent might be part of the access granted in this process. The evolved gateway may also provide a response to intrusion. When an intrusion/attack is detected on the end-system, the source of the attack if known can be disallowed from sending further traffic into the network.

Personal firewall vendors have begun to use functionality built in to the operating system to develop products for these end systems. These vendors are aided by the publishing of IP callout APIs and IP Hook API in the Windows operating system environment, which allows them to intercept traffic directly from the IP stack. Using these methods, personal firewall vendors can build sufficiently sophisticated functionality on the end-system as firewalls provide in the middle of the network today. However, this still forces the personal firewall vendors to implement arbitrary protocol stacks for analysis of IP packets.

Another problem existing with current technology in this area relates to the level of security between end systems. Current security protocols in proposed distributed firewalls provide authentication only at the machine level. For example, the Internet Key Exchange (IKE) security protocol currently allows only for authentication between trusted sites at the machine level. Unfortunately, anyone who accesses a secure machine may gain access to the network. That is, the current security protocols do not provide a mechanism to authenticate individual users as opposed to individual machines. Current systems have no way of knowing when or if multiple different users are accessing the secure machine to gain access to the network resources. This presents a security problem in that different users accessing a secure workstation may not all have the same level of network access granted to them, and yet the current security mechanisms do not differentiate these different users.

### BRIEF SUMMARY OF THE INVENTION

The distributed firewall architecture of the present invention performs user authentication at a first level to establish a user security context for traffic from that user. Once authenticated, an authority context provides authorization for subsequent traffic from that user. This authority context may be based on an underlying policy, and may provide authority for particular types of traffic from that user, access to particular applications by that user, etc. Additionally, the system of the present invention includes the ability and a user interface (UI) to allow a user/process/application to define its own access control.

The linking of the user security context from the traffic to the application is accomplished by enabling IPSec on a socket via Winsock APIs and forcing the socket to be bound in exclusive mode so that the context of the binder of the socket is preserved. The most common policy definitions may be included by default (leave NULL the value in the API). Specific policy definitions may be set as desired.

Extensions of Internet key exchange protocol (IKE) to provide the desired user authentication plus application/purpose (identity) are also provided. The end-system creates an aggregate of all possible authentication methods to validate the IKE main mode (MM) request from an initiator. The end-system will accept any of the aggregate authentication methods to complete the MM. However, in quick mode (QM), the end-system will make sure that the authentication mechanism was acceptable, and check the incoming traffic to determine if it is authorized for the MM on which it is being negotiated. If it is, the QM completes, and if not the end-system notifies the initiator of the failure. If the initiator wants that particular traffic type, it will have to reinitiate the MM using a different credential.

In order to allow users, process/application to define their own access control, the present invention provides an architecture for authentication and access control that maintains a clean line between authentication (the job of IKE), and authorization. The architecture includes pluggable authorization module(s) that are called after IKE has successfully authenticated the peer, but before the connection is allowed to complete. This allows the UI driven authorization as well as support for the Winsock/IPSec APIs in the Windows environment and support for IPSec functionality for other operating system platforms. The basic scenarios to enable are: restriction of access to a given subset of certificates, all issued by the same root; restriction of access to a given subset based upon kerberos ID; the allowance of someone with certification attributes “X” HTTP access, and someone with certification attributes “Y” L2tp access, where both certifications are issued by the same certification authority (CA); and mapping a peer's credential to a user account and perform an ACL check against some object for allowed access.

Additional features and advantages of the invention will be made apparent from the following detailed description of illustrative embodiments which proceeds with reference to the accompanying figures.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a block diagram generally illustrating an exemplary computer system on which the present invention resides;

FIG. 2 is a simplified illustration of a user interface (UI) forming an aspect of an exemplary embodiment of the present invention;

FIG. 3 is a simplified architectural diagram illustrating aspects of the distributed firewall (DFW) of the present invention;

FIG. 4 is a simplified communication flow diagram illustrating aspects of the system of the present invention;

FIG. 5 is a simplified environment diagram illustrating a connection between a peer end system and a server having multiple services and clients available applicable to the system of the present invention;

FIG. 6 is a simplified communication flow diagram illustrating additional aspects of the system of the present invention; and

FIG. 7 is a simplified environment diagram illustrating prior deployment of intermediate firewalls to protect private networks.

### DETAILED DESCRIPTION OF THE INVENTION

Turning to the drawings, wherein like reference numerals refer to like elements, the invention is illustrated as being implemented in a suitable computing environment. Although not required, the invention will be described in the general context of computer-executable instructions, such as program modules, being executed by a personal computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, microprocessor based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices. While the examples herein illustrate implementations utilizing the Microsoft Windows® operating system, the invention may also be implemented with other operating systems (e.g, Unix®, Linux®t, etc.). Indeed, one skilled in the art will recognize that the present invention is not limited to a particular operating system, and its features and functions may be advantageously deployed in various platforms.

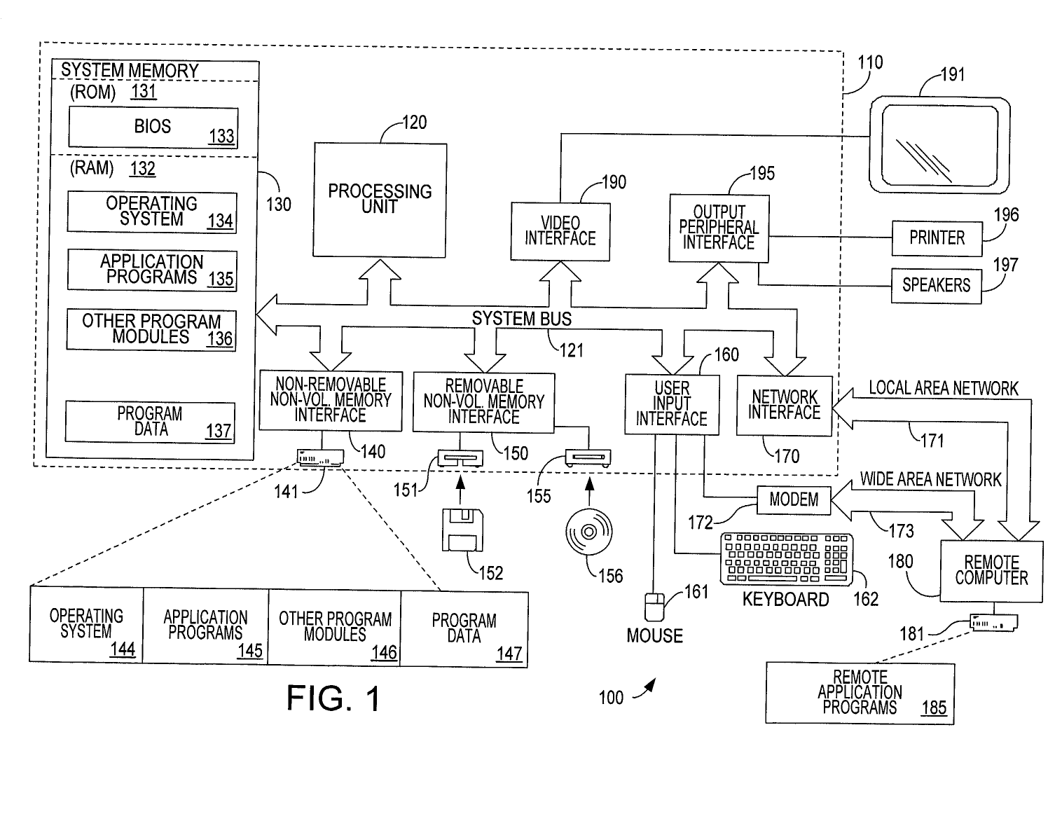

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Associate (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers hereto illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be another personal computer, a server, a router, a network PC, a peer device or other common network node, and typically includes many or all of the elements described above relative to the personal computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the personal computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the personal computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

In the description that follows, the invention will be described with reference to acts and symbolic representations of operations that are performed by one or more computer, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is being described in the foregoing context, it is not meant to be limiting as those of skill in the art will appreciate that various of the acts and operation described hereinafter may also be implemented in hardware.

The system and method of the present invention provides how an end-system should operate securely on an IP network. This functionality is provided mainly by integrating personal firewall behavior, IPSec behavior, extending IPSec to enable user-based authenticated and authorized access control, and enabling protocol callouts on the end-system protocol stack for firewall applications to provide the same inspection they have today. This preserves the functionality of a stateful packet filter, which reduces the amount of traffic that an end-system receives. This functionality is provided because there are a number of cases where trusted IP communication is not feasible or desired.

The distributed firewall (DFW) of the present invention provides a method for deploying IPSec that does not require application awareness. This functionality may preferably be integrated into the operating system, or may, alternatively be supplied by an application installed on an end system. By simply enabling the distributed firewall of the present invention, whenever two firewalls run into each other, they automatically go secure with IPSec, which provides ideal functionality for intranets.

Through the system and method of the present invention, various deployment scenarios are possible, all of which receive the benefits of the distributed firewall (DFW) functionality provided, as will be discussed more fully below. In a locally managed deployment, such as a consumer, small office/home office (SOHO), small business, unmanaged larger business, etc., the end-system is typically directly connected to Internet via DSL, Cable, Ethernet, T1, etc. In this deployment scenario, the user enables DFW whenever the end-system is connected to the Internet to protect against clear text probing, unwanted connection attempts, hack attempts, etc.

In order to securely connect with an end system having the DFW in this scenario, users utilize digital ID certificates. When a user sends secure/multipurpose Internet mail extensions (S/MIME) signed email to, e.g., a family member, the email contains their certification. The DFW protected machine may also have stored in its directory an address book of people with their digital IDs (certificates) against which the incoming email may be checked. In either event, the user may read the family member's S/MIME email, and can save their certification identity in the identities or contacts list or address book. In a corporate environment, a corporate address book or directory may be used that contains authorized users and groups. The user may use a DFW console UI to browse the contact list or corporate address book or directory of users/groups and to add names to the authorization list to enable the DFW to accept incoming connections from those users.

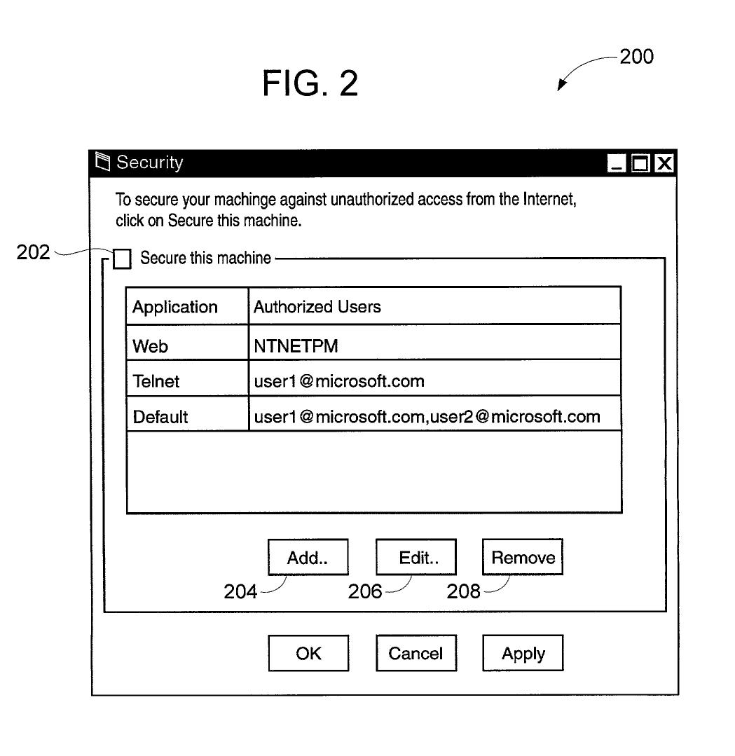

An exemplary embodiment of a user interface (UI) 200 is illustrated in FIG. 2. This exemplary UI console 200 provides the ability for the user to secure the end system against unauthorized access by providing, for example, a simple check box 202 option for the user. This UI 200 also provides the ability for the user to select or develop different authorizations for the various applications by providing ADD 204, EDIT 206, and REMOVE 208 buttons on the UI. This FIG. 2 illustrates some exemplary authorizations associating applications with authorized users.

It should be noted that certificates map best to implementation mechanisms, but they typically do not contain group information useful for corporate access control. Therefore, if certificates are used to identify authorized users, the access authorization is built on the content in the certificate, e.g. “issuer or root=Microsoft ITG root CA.” Otherwise, the certificate is mapped to a domain user principle to gain group membership sufficient to check the access control lists (ACLs).

To request access to a DFW machine, a user utilizes the DFW console to send a mail message (S/MIME email) to another DFW protected machine. The recipient sees the list of pending access requests and may selectively authorize access his DFW machine. The user may also configure applications to authorize certain users to go through the DFW unprotected. This means that the user can identify the application and take an authorization step to tell the DFW how to authenticate the application request. This is required to prevent general APIs used by Trojan-type attacks. The user can then, e.g., play Internet games in the clear via application control of what limited traffic must be allowed through firewall.

The DFW of the present invention also includes a diagnostic mode that is enabled to provide a running readout of changes in the distributed firewall state. Additionally, the DFW can be configured to detect clear text attacks and failures to authenticate or to be authorized. The DFW logs these, alerts the user, and takes user-prescribed action. The UI may be used to select, via checkbox type UI, this desired user-prescribed action.

In an embodiment of the present invention, DFW policy can leverage browser security (e.g. Internet Explorer (IE)) defined security zones, such as local subnets, trusted sites list, intranet, Internet. User access authorization based on these zones is then provided by the infrastructure. Such allows an additional property of the access rule to say “allow user.1 access, when he is coming from the intranet.trusted site.”

Trojan defense may also be provided in some implementations of the system of the present invention. The problem addressed by this defense is how to more securely configure applications to work through the firewall, rather than give the application total authorization to punch any hole they want because of the risk that they may run Trojans. The DFW of the present invention instead learns how to pass an application through the DFW without the application itself calling hole punching APIs. DFW has a learning phase to recognize how an application communicates so that it can build an access policy for that application. Thus during normal operation, Trojans run by the application cannot open holes in the firewall. This is because the “rule” for that application exists on it's own within DFW. A user can enable and disable that rule, or tell DFW to learn a new rule for the application if it becomes apparent that a new rule is needed.

A second deployment scenario is a centrally managed medium sized to Enterprise client. In this type of deployment, corporate system administrators use a central DFW policy to ensure that their end systems are protected from outside and inside attack, and that they may communicate securely between each other. The policy may be built just like the end-system policy just discussed, and ACLs would be delivered to the end systems as part of that policy. Distributed integration with edge devices is made as transparent as possible through the system of the present invention so that end system authorizations can be communicated to and, if desired, negotiated by edge gateways. Network/domain administrators are able through the system of the present invention to specify any locally specifiable policy in a centralized manner.

For example, the administrator of a host to establish a policy that says “grant usera@company1.com the right to reach user2@company2.com web server for 48 hours.” An administrator of a home gateway box may develop a policy such as “grant the service provider the right to monitor SNMP over IPSEC.” Further, an administrator of a home gateway may allow home appliances out through the firewall for reporting status, and may allow synchronization of family WinCE PocketPCs wireless on the Internet with the home PCs to get files (e.g. shopping list, MP3s, ebooks, etc.).

The distributed firewall system of the present invention also allows the enforcement of security requirements. For example, incoming clear text traffic can be completely blocked from boot. Likewise, outgoing traffic can be completely blocked from boot. The system running the distributed firewall can be set to receive in silent mode only, i.e. it is not willing to negotiate with anyone other than sites from specific zones or IP addresses or using DNS name zones like TCP wrappers specified in its policy. Incoming traffic can also be denied unless the host (or an application on the host) requests it. The host may pre-configure incoming clear connections, and may dynamically allow incoming connections for its own outbound connection requests. Further, the DFW of the present invention may be configured to not always force client authentication to the remote system. It has a simple user configuration with expected security results, and may utilize a default configuration to provide strong security. To allow greater flexibility, the DFW also allows anonymous, unprotected, communication and provides logging to show all changes to the security state. As discussed above, the DFW is operationally resistant to Trojan horse programs like the “I LOVE YOU” virus. Further, console logon of the Local Administrator is preferably not prevented, and a fail-safe to prevent access from network, or outbound exposure is provided.

As may now be apparent, the deployment requirements for the DFW of the present invention leads to greater use of trusted group communications via IPSec. However it is important that getting a certificate for users be very easy. This requires RFC supported certificate enrollment protocols, CA vendor products available to service requests, and service providers in the business of providing level 1 user certificates (email style). To support the user-based incoming access control, the IKE initiator must identify the user in a context meaningful to the responder for access control checks.

The DFW of the present invention automatically establishes IPSec communication. It utilizes outbound state to know that a connection is being attempted in the clear, and can initiate security when required. The DFW can be configured to send ICMP_DEST_UNREACH or a similar message when it drops packets on receive. The sender receives the dest_unreach message containing the first 40 bytes of the rejected packet, which would match an open connection state. Thus the sender would then know to initiate IPSec. Such behavior is ideal typically for corporate network use so that the originating system can easily initiate security for all traffic when it hits a firewall-protected end system. Using this could be enabled on a per-zone basis, so that Internet scanning does not show firewall protection.

In one embodiment of the present invention, the call to IKE to negotiate examines the DFW access rules to see what credential to use and/or how to negotiate with that system. The IKE QM SA payload is extended to allow the proposal of the specific protocol and port that was in the clear packet connection request, and to include an “all traffic” selector by default. Thus QM policy check on the responder has sufficient information to apply port level access controls, and no a priori configuration for a QM filter to propose is required.

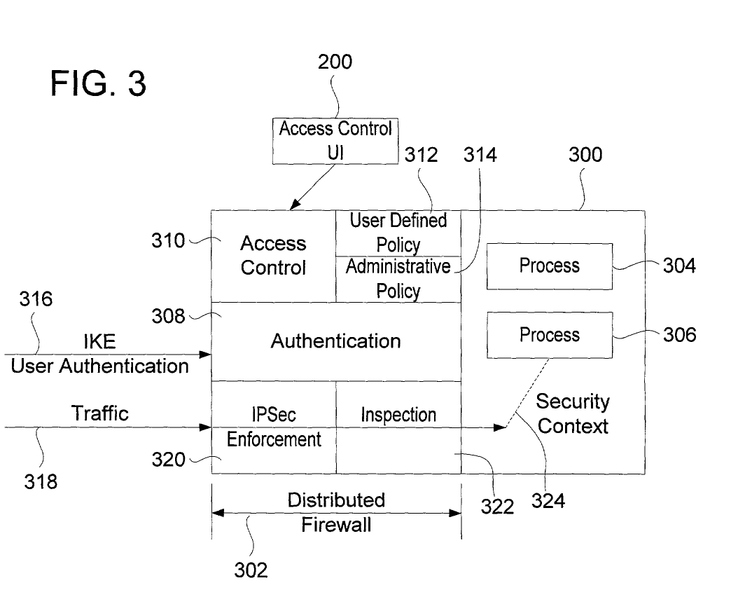

The architecture of the distributed firewall system of the present invention may be visualized as illustrated in FIG. 3. In this FIG. 3, the end system 300 may be thought of as having a front end distributed firewall portion 302, and may include multiple processes 304, 306 available therein. The distributed firewall portion 302 contains an authentication portion 308 that provides the security authentication required by the system of the present invention. This authentication utilizes as an overlay an access control portion 310 which draws upon user-defined policy 312 and/or administrative policy defined by a network administrator. As discussed previously, this policy and access control may be defined/modified by a user through an access control UI 200. In a preferred embodiment of the present invention, the authentication portion 308 of the distributed firewall system 302 of the present invention utilizes the Internet Key Exchange (IKE) security protocol in a modified form to provide user authentication of incoming connect attempts 316. This authentication process is defined more fully herein.

Once the user has been authenticated in section 308, the enforcement of the access control policy as traffic 318 is sent to the end system 300 takes place in an enforcement section 320. In a preferred embodiment of the instant invention, the enforcement is accomplished by IPSec. The incoming traffic 318 traverses this enforcement section 320 and may be inspected (e.g. virus checking) in portion 322. At this point, the traffic may be associated with an authorized process through a security context 324 defined in the user defined or administrative policy 312, 314. This security context may, for example, allow particular users access to selected processes, while disallowing access to different processes by that same user.

User authentication in IKE is necessary to support the personal or distributed firewall deployment. User authentication will also enable winsock connections to be tied to the user who initiated the traffic. This is important because only the end station can provide and guarantee the end user identity.

There are many different usages for authentication in IKE in the system of the present invention. The different authentication usages are normal machine authentication of both peers, user authentication of client, machine authentication of server, single user on client (ex. L2tp dialup), single server with different authentication methods for different traffic types (where each traffic type may be thought of as a different version of the “System” user) (Ex. Web and Radius server), and multiple users on the machine, each with multiple traffic streams to a given server (Ex. Terminal server with winsock\ipsec). The user authentication scheme must stand up to all these usages, at a minimum. There are, of course, many tradeoffs, and there is no universal mechanism that trades all these principles off best. In the embodiments of the present invention, therefore, support for different types of authentication are presented.

Currently, machine to machine authentication exists. Therefore, the system of the present invention continues to support such authentication. The systems and methods for such authentication are well know in the art and are incorporated, e.g., in the Windows 2000 operating system.

Unlike prior systems, user authentication with single user is also provided. This is exemplified by a client dialing via L2tp/IPSec to a server. Preferably, the client does not need to have both machine and user certificates to make the call. In one embodiment, IKE is configured to allow the user certificates to be used in the currently defined main mode. This involves little code change in IKE. However, this configuration does not extend to multiple users.

In a preferred embodiment, full user authentication is provided. This functionality is provided in the system of the present invention with very few IKE protocol modifications. In its basic operation, the Initiator knows what specific credentials to use for the given traffic flow. The responder creates an aggregate of all possible authentications to validate the MM request. The responder allows MMs to complete, but doesn't check the specific authentication until QM.

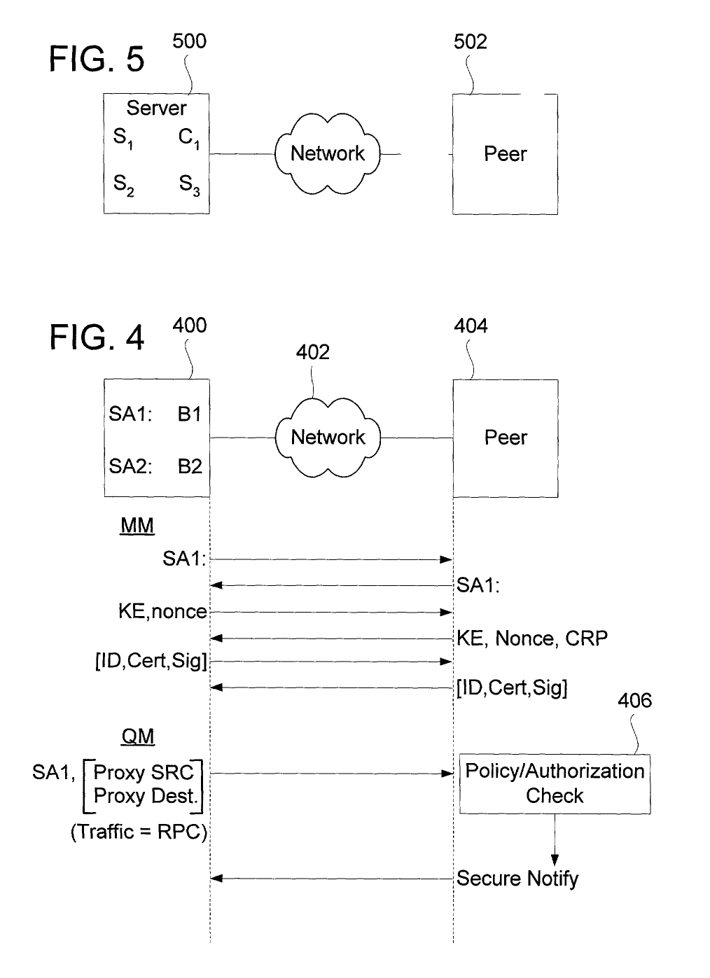

FIG. 4 illustrates this full user authentication in greater detail. In this FIG. 4, a machine 400 that is accessible by multiple users is connected through a network 402 to an end system peer machine 404 incorporating the distributed firewall system of the present invention. In this example, the first user of machine 400 has a first security association SA1 with a certificate B1, and the second user has a second security association SA2 with a different certificate B2. The authorization policy in end system 404 specifies that the user having SA1 and certificate B1 is granted SMB access, while the user with the higher security association SA2 and certificate B2 is granted administrative privileges such as remote procedure calls (RPC).

During the initial user authentication, the communication between the machine 400 and the end system 404 attempts to complete the IKE main mode (MM). Within the peer end system 404, the authentication connection policy is formed as an aggregate of all connection policies since, at this first level of authentication, it is not z z ~ known what type of access is being requested by a user on machine 400. Therefore, so long as any authorized user attempts to connect, the authentication in MM will complete. However, during the IKE Quick Mode (QM), the system of the present invention performs a policy/authorization check 406 once the user sends a particular type of traffic. In the example of FIG. 4, the user having only SMB authorization is initially authenticated during the main mode, but once it attempts to negotiate filters that would allow RPC traffic to be sent during the Quick Mode, the policy/authorization check 406 determines that the authenticated user is attempting to exceed its authority as defined by the policy within the end system 404. As such, the end system 404 sends a secure notify back to the user on machine 400 to inform it that it is sending traffic which is not authorized by the connection policy in end system 404. If the user wishes to send this type of traffic, it will have to reinitiate the main mode using the other security association SA2 and the associated certificate B2. Otherwise, it may simply choose to engage in the authorized traffic for the authentication security association and certificate used. In one embodiment of the present invention, the secure notify does not tell the user which certificate is required for the attempted traffic. However, such notification may be made if desired.

As a further example, assume that a Server protects HTTP with cert A and L2tp with cert B. The Server creates an aggregate MM policy of all authentication methods (both cert A and cert B). As a responder, the server will accept a MM established with either credential. As an initiator, the server will only propose the specific one. When the client initiates an HTTP connection and uses cert A for the MM, the server accepts the MM. Now, in QM, the server will need to check that the incoming traffic type is valid for the MM on which it is being negotiated. If the traffic type is valid for the cert, the QM completes. If not, the server sends a notify to the client, and the client will need to reinitiate using a different credential in MM as discussed above. Also, it is be beneficial for the client to remember which credential to use for each type of traffic to reduce the necessity of this reinitiation. This is especially true in situations such as illustrated in FIG. 5 where a server 500 has multiple services S₁₋₃ available and accessible by a peer 502.

For the situation where there are multiple users, the stack plumbing is maintained to keep the traffic distinct. For example, assume there are two users, U1 (for HTTP using cert A) and U2 (for HTTP using cert A) both talking to the server in the example above. Now, each will create its own MM, and all QMs for the given user will be on its own MM. The server can rekey a QM, since the underlying MM will serve to pick the correct user. If the server needs to rekey the MM, then this requires the only IKE protocol change. The server will need to inform the peer for which user it is rekeying. It can do this by providing a hint in MM, like by sending an additional ID payload for the expected peer's ID. In the kerberos case, since this must be known right away, so the hint is sent in the SA payload, too. Id hints will fail for preshared keys if the ID remains the IP. For named based IDs, this is also acceptable.

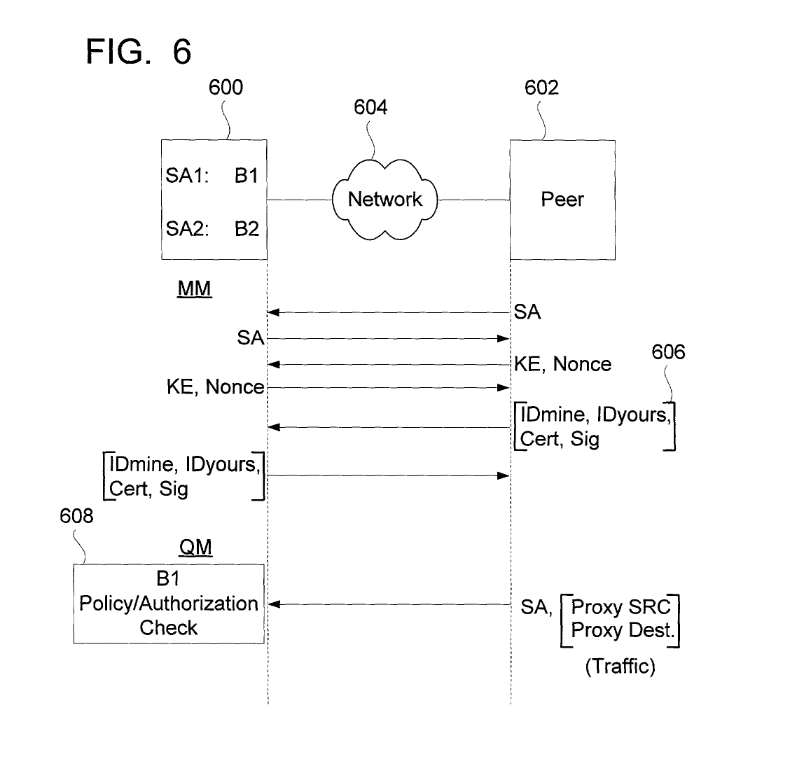

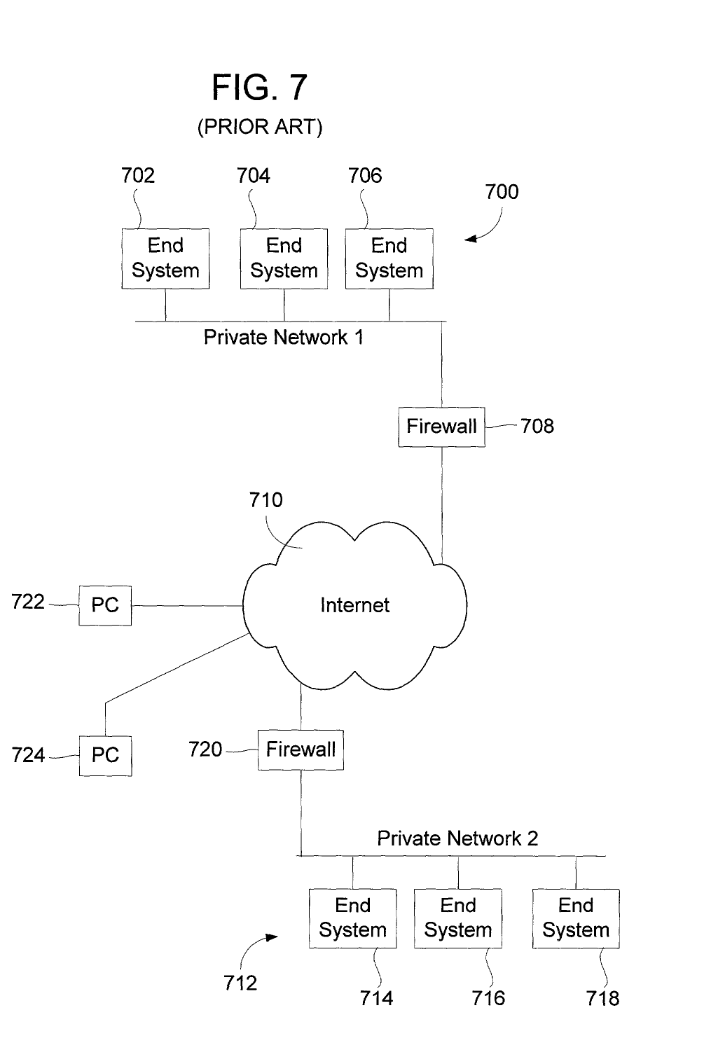

The benefit of providing the ID hints may be appreciated through an analysis of the communication diagram of FIG. 6. In this illustration, a machine 600 is coupled to a peer end system 602 through a network 604. However, unlike the previously described connection of FIG. 4, in this illustration the peer end system 602 is attempting to connect to a particular user on machine 600. The main mode authentication communication begins as is typical for IKE with the peer end system 602 sending its security association to machine 600. However, since peer 602 desires to connect to a specific user on machine 600, the MM negotiation also includes the transmission from peer 602 its ID and the ID of the user to whom it wishes to connect as illustrated by transmission 606. Once the main mode completes and the peer end system 602 begins to send its traffic to machine 600, the proper user with whom the main mode has completed will perform its policy/authorization check 608 in the QM. As discussed above, if the attempted traffic exceeds the authorization of the particular user with whom the MM has completed, a secure notify will be transmitted to allow the peer 602 to either reinitiate the main mode authentication or to modify its traffic for the authority it has been granted.

An advantage of this system is that there are very little IKE protocol changes necessary. The ID hint in MM will not open any security holes since it will generally be encrypted. Also, as will be described more fully below, this technique fits in with the authorization model of FIG. 3 very well. It solves the problems associated with multiple services with different authentications, multiple users on same machine, etc. as illustrated in FIG. 5. Further, as experience tells, simpler is typically more secure (at least easier to prove secure and implement securely), and it provided easier interoperability. As a further benefit, only hints at the peer's ID for this MM are sent, which are totally independent of all specific traffic flows.

IKE does not authorize access to resources. While this functionality can be implicitly built into the certifications as a token authorization model, it is not encouraged. In one embodiment of the present invention, therefore, the authorization will occur via pluggable callouts that IKE will call once the mutual authentication has completed. It is then up to the authorization layer to determine if it wants to grant network access or not to the given peer entity. IKE can enforce that decision by either allowing the traffic, or dropping the SAs.

Once the user has been authenticated as described above, its user security context is linked from the traffic to the application to which it is authorized as illustrated by dashed line # in FIG. 3. In one embodiment of the present invention, this is accomplished by enabling IPSec on a socket via the winsock APIs, and forcing the socket to be bound in exclusive mode. This ensures that the context of the binder of the socket is preserved. Preferably, the winsock extensions to easily enable IPSec on sockets are defined as follows:

int WSAIoctl(

SOCKET s,

DWORD dwIoControlCode,

LPVOID lpvInBuffer,

DWORD chInBuffer,

LPVOID lpvOutBuffer,

DWORD cbOutBuffer,

LPDWORD lpcbBytesReturned,

LPWSAOVERLAPPED lpOverlapped,

LPWSAOVERLAPPED_COMPLETION_ROUTINE lpCompletionRoutine

);

typedef struct_IPSEC_STRONG_AUTH {

DWORD dwStrongAuthSize;

DWORD dwStrongAuthType;

BYTE * pStrongAuthParams;

} IPSEC_STRONG_AUTH;

typedef struct_IPSEC_POLICY {

wchar_t *MainModePolicyName;

wchar_t *QuickModePolicyName;

IPSEC_STRONG_AUTH *pStrongAuthParams;

MM_AUTH_METHODS *pMMAuthMethods;

const struct sockaddr *pPeerSocket;

int PeerSocketLength;

DWORD dwFlags;

} IPSEC_POLICY;

#define IPSEC_WSA_ASYNCHRONOUS_CONNECT 0×00000001

#define IPSEC_WSA_FAIL_CONNECT_ON_STRONG_AUTH_FAIL 0×00000002

IPSec is enabled via the WSAIoctl call. LpvInBuffer is a pointer to an IPSEC_POLICY. For the MainModePolicyName, a NULL defaults to a default MM policy. Otherwise this specifies the MM policy by name. Likewise, for the QuickModePolicyName, a NULL defaults to a default QM policy. Otherwise, it specifies the QM policy to use by name. PstrongAuthParams contains encoding for extra checking for the connection. For example, this can be specified to allow a client to pass in a peer DNS name to enable SSL-like certification checks. For PMMAuthMethods, a NULL defaults to default methods, or specific authorization methods may be specified. PPeerSocket specifies the peer's address/port, and is necessary only if the connect is not called (i.e. server side) and one wants to secure to a specific subnet. NULL defaults to INADDR_ANY. The DwFlags IPSEC_WSA_ASYNCHRONOUS_CONNECT is specified to not drive IKE at WSAConnect time and instead wait until the time the first packet is sent. This is useful for connection-oriented sockets in the UDP case where calling WSAConnect does not already hit the wire. PPeerSocket is also used for connection-less UDP sockets to specify the peer. Standard WSA errors, obtained by calling WSAGetLastError( ) are provided.

On Connect, if WSAIoctl had previously been called, IPSec policy will be then applied to the peer in question. If Connect will not be called, as will be the case in some connectionless cases and server side, then the application must use WSAIoctl, passing in the IPSEC_POLICY buffer, including specifying the PeerFilter, to enable security.

IPSec support is provided as a winsock helper. This intercepts WSA calls, and allows either pre or post extension processing. In the case of WSAConnect, the IPSec helper will be called before the connect begins. WSAConnect can only be called after a bind. Similarly, the WSAIoctl for IPSec must be called only after a bind. When either is called, it translates into calls to SPD to add MainMode and QuickMode filters to protect the given traffic. The filters will be specified as tightly as possible. In the WSAConnect case, the full source address and port and protocol from the bind are known, and the destination address and port from the connect are also known. Therefore, the system may use the fully specified 5-tuple.

In the WSAIoctl( ), the user has more flexibility. The below examples of normal socket usage will clarify the acceptable parameters. It can be called anytime after a bind, and will plumb filters based on the PeerFilter. Due to the asynchronous nature of winsock, for best security, WSAIoctl must be used before any traffic is sent on the socket.

The only notification the IPSec helper needs is on pre-Connect and on close. The reason the system of the present invention does not need pre-accept is the following. If the system is trying to secure a TCP connection attempt, then TCP packets must flow before the Accept completes. Hence, policy must be in place before the Accept. IKE already handles the dynamic filter plumbing, which is necessary in the connection-less cases. However, it is useful to process pre-connect notifies for the cleanup case. When the pre-connect notify hits, there will already be a dynamically plumbed more specific filter added by IKE. When this socket gets closed, however, the system needs this dynamically plumbed filter to get cleaned up. Thus, the helper will open a handle to the filter that IKE created during the pre-accept notify processing. When the socket is closed, this handle will be closed. SPD will see that its refcount=1 and notify IKE to delete the filter. When the socket is closed, all filters are removed. This includes the filters plumbed by the winsock helper as well as the dynamic filters plumbed by IKE.

Using WSAConnect( ) with default setting will cause the helper to call the API to initiate the IKE negotiation. This will allow WSAConnect( ) to return with the appropriate error code if the IKE attempt fails. In addition, informational errors can be returned, signaling cases like, e.g., the strong authentication for the server's certification could not be verified. However, the connection is still up. This will allow the application to make choices if the connection should proceed or not.

An important, commonly used Winsock option is the non-blocking (asynchronous) connect. However, making RPC calls and grabbing SPD locks during a non-blocking connect could potentially block. A solution in one embodiment is to make a single asynchronous RPC call from client to server to add all the IPSec policy. However, since the worst case is that the non-blocking connect that enables IPSec will block during the short interval that policy is added and since no potential deadlocks can occur even if the LSA RPC server thread itself is making IPSec/Winsock socket calls, this solution is not required in another embodiment of the present invention. In this alternate embodiment, nothing more serious than a slight performance degradation during the non-blocking connect call occurs.

Since it is possible that a Proxy may be running on the client as well, the remote address that the base Winsock provider sees will not be the final destination, but instead will be the destination of the proxy server. In such a situation, IPSec will be set up between the client and the proxy server, and not fully end-to-end. In one embodiment of the present invention, this is detected at connection time and the client is warned that end-to-end security is being violated. The end client can query out the filter/security actually negotiated to determine if some proxy is in the path.

Another potential problem is for someone plugging in below the base Winsock provider and modifying the packets before they hit IPSec. This will cause these packets to bypass the filter, and potentially go out unsecured. The system of the present invention solves this by adding plumbing from Winsock to the stack and to IPSec that requires that this traffic is going out a secured socket. Then, IPSec can verify that there is a filter present to protect that traffic, and if that filter is not present, to drop the packet. Alternatively, the system of the present invention may simply warn about the problem if third parties install their TDI shims at this point.

The system of the present invention also guarantees that traffic does not leak out on closing sockets. This is hard in the TCP case, since many servers commonly close a socket with the DON'T_LINGER option, which allows TCP to send the final packets and close off the state in the background with all user mode states gone. This is clearly unacceptable from an IPSec standpoint. The options are to force sockets into LINGER mode, and make them wait for all TCP states to be closed before the close returns, or to allow close to return immediately, without having closed the IPSec state. Each close will need to fork a thread to handle this, manage the IPSec state, and wait for a notification from TCP that the state has been freed. Another option is that closing TCP close completes on the client, but gets pended in SPD. SPD will need to wait for notification from TCP (or from IPSec) that it is ok to really free the state.

In an embodiment of the present invention utilizing the first option, the common tradeoff is sacrificing performance for security and architectural cleanliness in the short term. In a preferred embodiment, all of the policy management APIs are put into the kernel as a client of the kernel APIs. Then, this kernel piece will be notified when TCP is done, which will allow for cleanup of all IPSec state. In an embodiment utilizing the second option, the only ones concerned about the delay in closesocket will be big server applications that want high performance. Forking a thread results in increased overhead and may likely slow them more overall than waiting the extra little bit for TCP to finish. The third option solves the problem best from the client perspective, but increases complexity and implementation issues.

In an embodiment that guarantees that a clear-text leak on close is eliminated the plumbing is built as follows. Wshtcpip calls TCP on the socket to set the IPSEC_ENABLED flag. TCP passes this flag to IPSec on each packet, and IPSec does its normal processing. However, before returning to TCP, it checks if it would have returned clear-text. If it would have, and the IPSEC_ENABLED flag is set, the packet is instead dropped. This is necessary if TCP cannot guarantee that even upon waiting for the linger option with an indefinite timeout, that packets could still leak out.

The following demonstrates a connection oriented socket example:

Server:

sockets( ): create socket

bind( ) : sets addr and port server is listening on

WSAIoctl(IPSecPolicy);

listens( ) : create queue

accept( ): accept request from queue

Client:

sockets( )

bind( ): sets local addr, port

WSAConnect(IPSecPolicy);

Now, at WSAConnect time, the layered winsock IPSec helper will plumb filters with as much information as is available. In the server case the filters will have the filter format of: src addr→dst addr, src port, dst port, protocol; ServerBoundIp→ any, sport, *, protocol TCP; and any→ServerBoundIp, *, sport, protocol TCP. On the client, the filter is ClientBoundIp→server, cport, sport, TCP, mirrored.

The canonical model is a server listening on a well-known port, and the client connecting from a random port. The server will dynamically plumb a more specific filter on receiving an IKE negotiation from the client, such as ServerBoundIp→client, sport,cport, protocol TCP, mirrored. If this is a TCP connection, then when the client calls WSAConnect, the IKE negotiation is triggered, and WSAConnect will not return unless IKE succeeds. In the UDP connection-oriented model, this same behavior will occur by default. Specifying the IPSEC_WSA_ASYNCHRONOUS_CONNECT will wait until the first UDP packet is actually sent to drive the IKE negotiation.

For the connectionless situation, the winsock calls are as follows:

socket( )

bind( )

WSAIoctl(IPsecPolicy);

sendto( ) recvfrom( ) : specifying IP\port to send\recv

As in the connection-oriented case, there is a distinction between client and server. In this context, the client is the sender (via sendto( ), and the server is the receiver (via recvfrom( ) of the initial packet. For the client, the client needs to specify (in pPeerFilter of the IPSEC_POLICY) at least the port of the server to which he is talking. The client filters look like me→server (or any), cport, sport, UDP, mirrored, and me→server (or any), cport, *, UDP, mirrored (allows server to float ports). On the server, as in the connection-oriented case, no client port is specified. The filter is me→any, sport, *, UDP, mirrored.

After the IPSec connection is established, the dynamic filter is plumbed as me→client, sport,cport, UDP, mirrored. Now, if the server desires to float to a new port, it will need to create a new socket, bind, WSAIoctl(IPsecPolicy,Peer=client,cport), and sendto( ) the client. Essentially, the server will become a client of the original client. The original client will become a server listening on the well-known port cport. For example, if the server desires to float to sport', for servicing this connection with the client, the filters will be (after the bind, and WSAIoctl) me→client, sport',cport, UDP, mirrored, and me→client, sport',* UDP, mirrored (float filter). Prior to any sendto to a new destination (or port), the client needs to do the WSAIoctl and specify the peer, and peer port.

The system of the present invention also properly cleans up on socket close. For connection oriented, server side clean up, when a forked off socket (from the accept) is closed, the pre-accept notify will have opened a handle to the dynamically added filter. Closing this handle will notify IKE and delete the filter from the SPD. When the main server socket is closed, the main server filter and all dynamically added filters underneath that filter are removed. For connection oriented, client side clean up, when the socket is closed, the main client filters are removed. In this situation there are no dynamic filters present. For connectionless, server side clean up, the filters are main: me→any, sport, *, and dynamic: me→client, sport, cport. Closing the socket removes the main filter, and the dynamic filters plumbed under the main filter. For connectionless, client side clean up, there are no dynamic filters. All filters are cleaned up on socket close.

In an embodiment of the present invention, cleaning up without closing is also possible. As long as the socket remains open, the filters will be present in the system. The only real question is what happens if the client crashes. In one embodiment a full cleanup of everything the client added is accomplished. This requires that each client has its own QM policy. Then, each filter for the client will hang off its own policy, and when the client crashes, the rundown routine will delete the policy, which will delete then notify IKE to delete IKE's dynamic filters. The expense of this is having multiple copies of the policy in the SPD, one for each client, and probably one for each socket. In an alternate embodiment, no duplicated policies in SPD are required. In this embodiment, when the client crashes the filters that the client plumbed will be deleted from the SPD. SPD will need to notify IKE to delete any more specific filters that were plumbed under these. This has the benefit of being much lower overhead, at the expense of creating another notification mechanism between IKE and SPD.

In the case of server-side connection-oriented filters, IKE will be plumbing dynamic filters for each new connection. Each of these filters will be based on the more general filter added by the winsock client. The Winsock added filter will be flagged IPSEC_DELETE_ALL_DYNAMIC_IKE_FILTERS. When this general server filter is deleted, SPD will notify IKE passing in the filter contents. IKE will look up all filters that are more specific versions of this filter, and delete its local handle to them. In the case of client-side filters, there is only one per-socket with no dynamic IKE filters.

The system of the present invention protects the filters while they are in the system. Security requires that the system absolutely cannot allow another application to delete the filters and let traffic go in the clear. Client-side, the helper holds handles to the filters. However, for the dynamic filters on the server, there is no notifications for new connections, and no way for the helper to grab handles to the filters. This is handled via IKE, which has handles to the filters, forcing them to remain. They will be deleted on timeout basis or if the client closes the socket.

The system also guarantees that more specific filters are not created by other, potentially malicious applications, such as other winsock clients that are running at exactly the same privilege level. This means that the system needs an IPSEC_PROTECT_MORE_SPECIFIC flag. This must prevent all SPD clients (including IKE) from adding more specific filters of a different policy. IKE will always be adding more specific filters of the same policy, which clearly cannot compromise any security.

The system of the present invention also guarantees that no other portions of the policy (MM/QM policy, MM authentication) are modifiable once a client sets its policy. In the current SPD architecture (not having handles to policy or auth objects), this will work as follows. If a filter is associated to a MM policy and authentication or QM policy, then set calls must fail on that policy. Delete calls for policies or authentication currently wait until all filters have been deleted, and then clean up the filter. However, new filters are needed to be added even if the policy has been flagged for deletion. The common scenario is that the client adds his filters, and then deletes the policy so it is flagged to go away when the filters are deleted. This will provide policy cleanup if the client crashes without closing his socket.

One of the goals of this API is to use IPSec and supply functionality similar to SSL. This is provided by the use of the pStrongAuthParams. This field will allow clients and servers to specify extra constraints to be placed upon the authentication process. These extra constraints may often be configurable in IPSec policy itself as well. If IKE fails to verify the strong authentication information, IKE will still allow the authentication and QM to complete (if possible). However, IKE will return an error in the socket connect. The WSAConnect application can then decide if it wants to allow the connection, or not. The SPD APIs will allow the user to query out the IKE MM info, and do whatever extra authentication checks it wants on the certification chain. This is not a security problem since the client application gets to decide if it wants to send any traffic or not, and can close the socket if the security is not acceptable. If the user does not want even this small hole, he can specify the IPSEC_WSA_FAIL_CONNECT_ON_STRONG_AUTH_FAIL, which eliminates this possibility.

There can be no such functionality for the server, since any callout to the client application would need to occur during the notification of some connection event, and pre-Accept notification cannot occur until the IKE SA is established. Thus, the only alternative is creating a pluggable infrastructure that allows IKE to callout for authorization checks on the server side. On server side, it is nearly always unacceptable for the connection to come up before full authentication and authorization has been performed.

If the client specifies a DNS name in the pStrongAuthParam, as well as creating an SPD policy that specifies one way certificate authentication (to be defined in IETF), then the system can get nearly identical behavior to SSL. The functionality is the same, and IPSec is stronger in that the outer TCP header is protected. Also, this API is much easier to use than the SSPI model and encrypt/decrypt message, so migrating users should not be difficult. One big advantage over SSL is that the client can send CRPs to the server. SSL does not allow for this mechanism. The system of the present invention also can do SSL anonymous, which provides no authentication, just encryption. This mode will create a use policy with a NULL pre-shared key on both sides.

IPSec needs a rich authorization model, but at the same time needs be separate from authentication. A clean line between authentication (the job of IKE), and authorization needs to be maintained. As introduced above, the architecture of the system of the present invention utilizes pluggable authorization module(s) that are called after IKE has successfully authenticated the peer, but before the connection is allowed to complete. This will allow UI driven authorization as well as support for the Winsock/IPSec APIs.

The basic scenarios to enable are to restrict access to a given subset of certificates, all issued by the same root, to restrict access to a given subset based upon kerberos ID, and to allow someone with certificate attributes “X” HTTP access, and someone with certificate attributes “Y” L2tp access, where both certificates are issued by the same CA.

Authorization schemes come and go, and the attributes that are important today may not be relevant 6 months from now. For this reason, it is essential that authorization be extremely flexible. This flexibility cannot be easily or cleanly achieved without a pluggable callout architecture. The user interface (see FIG. 2) allows for adding, removing, and enumerating plug-ins. There is a single API callback supported by each plugin defined below. It is up to the authorization module to determine if the connection is authorized. Of importance, the actual authorization is done outside of the core IKE functionality.

An exemplary API to provide this is as follows:

DWORD

InstallAuthorizationModule(IN wchar_t *ModuleFriendlyName, IN wchar_t *DllName);

DWORD

RemoveAuthorizationModule(IN wchar_t *ModuleFriendlyName);

DWORD

EnumAuthorizationModules( );

DWORD

AuthorizeCallback(IN IPSEC_QM_FILTER QmFilter,

IN IPSEC_QM_OFFER SelectedQmOffer,

IN IPSEC_MM_OFFER SelectedMmOffer,

IN MM_AUTH_ENUM MM_AUTH_ENUM MmAuthEnum,

IN IPSEC_BYTE BLOB MyId,

IN IPSEC_BYTE_BLOB PeerId,

IN HANDLE PeerHandle,

IN VOID * pCallbackContext)

A call back into an installed authorization module is made by IKE during Quick Mode after the peer's proxy IDs have been received. If certificate authentication has been done, then IKE will attempt to map the certificate to an NT account, and provide a handle to the peer's account in the PeerHandle field. QmFilter is the filter of traffic to authorize, SelectedQmOffer defines QM security attributes, SelectedMmOffer defines MM security attributes, MMAuthEnum lists the Auth Method selected for main mode, MyId is the ID in main mode (type depends on MMAuthEnum), PeerId is the peer ID in main mode (type depends on MMAuthEnum), PeerHandle is the handle to the peer's account for the ACL check, and PcallbackContext is the callback specific data. The API returns ERROR_SUCCESS if authorization is successful. Otherwise, it returns failure codes, e.g., win32 failure codes in one embodiment.

The common implementation will be if MMAuthEnum==IKE_SSPI, then kerberos authentication was used. Verify that the PeerId, which contains the kerberos ID is authorized for the traffic specified by QmFilter to be secured via the security parameters negotiated in MM and QM. Preferably a context to the peer's account in the kerberos case is provided as well. If MMAuthEnum==IKE_RSA_SIGNATURE, then a certificate based authentication was performed. The PeerHandle contains a handle to the peer's account, if such a mapping exists. This mapping of certificate to Peer Handle will be provided by a callout provided by SSL, also in LSA. This can be used to check for ACLs, and leverage the build-in security model. If the mapping failed, then checking the CertificateChains is all that is available.

In an alternate embodiment, mapping IKE Auth to an NT token is provided. This functionality is limited to domain members. In kerberos, only the “server” i.e. responder (one who does AcceptSecurityContext) gets a token to the peer. Thus, the system cannot do true bi-directional access checks with kerberos since the “server” could potentially initiate QMs after the client set it up, and the client would have no token against which to do access checks. To get around this the system of the present invention simply sets the QM limit to 1. Then, there is a guarantee that no unauthorized QMs can come in on the kerberos MM. Another option in the policy configuration could say to disallow incoming QMs, but allow outgoing QMs.

The system of the present invention provides a client of this API, and a UI to support it to give users the ability to specify authorization functionality. The IPSec UI configuration will allow users to browse to find an ACL-able object, and associate that object with a policy rule. This will enable authorization for this QM policy rule. The check will simply take the provided peer handle, and perform an ACL check against the object configured in policy. If this check fails, or the peer's handle could not be constructed at all, then the authorization will fail.

The IPSec policy is extended to also contain a LPTSTR pObjectName and a SE_OBJECT_TYPE for the type of the ACLed object. The authorization layer will call GetNamedSecurityInfo( ) to obtain the security descriptor in question, and then use AccessCheck( ) to perform the actual access verification. The UI also allows configurability as part of policy on a per object basis. Preferably, the network access implies GENERAL_READ and GENERAL_WRITE access. However, it may also involve GENERAL_EXECUTE depending on what the traffic is going.

As an example of a specific Cert authorization, assume that a mapping from each allowed user to a general account is created. An object that has R/W access granted only to this account is created, and the IPSec policy to authorize the traffic using this object is set. This is totally general, and any set of certifications can map to the single account. Another options is to have one account per user, and set the ACLs on the given object for the given user. This has the benefit of potentially getting auditing of which users came into the system.

In view of the many possible embodiments to which the principles of this invention may be applied, it should be recognized that the embodiment described herein with respect to the drawing figures is meant to be illustrative only and should not be taken as limiting the scope of invention. For example, those of skill in the art will recognize that the elements of the illustrated embodiment shown in software may be implemented in hardware and vice versa or that the illustrated embodiment can be modified in arrangement and detail without departing from the spirit of the invention. Therefore, the invention as described herein contemplates all such embodiments as may come within the scope of the following claims and equivalents thereof.

We claim:

1. A distributed firewall (DFW) for use on an end system, comprising:
an authentication component for providing user authentication for connection attempts from users attempting to access the end system via a network;
an access control component for providing purpose authorization for authenticated users based on rules in a connection policy associating users with purposes;
an enforcement component for enforcing the connection policy rule for the authenticated user from whom the traffic is sent as the traffic is received; and
wherein the authentication component utilizes an aggregate of the users in the connection policy to authenticate users.

2. The DFW of claim 1, wherein the authentication component utilizes Internet key exchange (IKE) protocol to authenticate users in IKE main mode (MM) based on the aggregate of users in the connection policy.

3. The DFW of claim 2, wherein the authentication component utilizes the rule in the connection policy associated with the authenticated user in IKE quick mode (QM) to complete the authentication.

4. The DFW of claim 3, wherein the authentication component transmits a secure notify message to the authenticated user when the authenticated user sends traffic in QM that exceeds an authority governed by the rule in the connection policy associated with the authenticated user.

5. The DFW of claim 3, wherein the enforcement component utilizes Internet protocol security (IPSec) protocol to maintain security of communications from the authenticated user when the communications are within the rule in the connection policy.

6. The DFW of claim 5, wherein the enforcement component enables IPSec on a socket for communications from the authenticated user and binds the socket in exclusive mode so that the context of the binder of the socket is preserved.

7. The DFW of claim 1, further comprising an inspection component for inspecting packets from an authenticated user.

8. The DFW of claim 1, wherein the connection policy is defined in a pluggable policy component.

9. The DFW of claim 8, wherein the pluggable policy component is downloaded from a centralized administrative policy.

10. The DFW of claim 8, wherein the pluggable policy component is modifiable on the end system.

11. The DFW of claim 10, further comprising an access control component through which the connection policy may be defined.

12. The DFW of claim 1, further comprising an access control component having a user interface (UI) through which the connection policy is defined.

13. A method of providing user authentication/authorization in a distributed firewall on an end system, comprising the steps of:
receiving a connection request from a user;
performing main mode (MM) authentication of the connection request via Internet key exchange (IKE) protocol based on an aggregate of users listed in a connection policy;
receiving communications from the user;
performing quick mode (QM) authentication of the communications via IKE based on a rule for the user in the connection policy;
completing the QM authentication when the communications are within a scope of the rule for the user in the connection policy; and
enforcing the rule for the user for subsequent communication when the QM completes.

14. The method of claim 13, wherein the step of performing MM authentication comprises the steps of:
checking a certificate of the connection request against an aggregate listing of all authorized users in the connection policy; and
completing MM authentication when the certificate matches an entry in the aggregate listing.

15. The method of claim 13, further comprising the step of transmitting a secure notify message to the user when the communications attempt to exceed the rule for the user in the connection policy.

16. The method of claim 13, wherein the step of enforcing the rule for the user for subsequent communication comprises the steps of enabling IPSec on a socket for the communication, and forcing the socket to be bound in exclusive mode.

17. The method of claim 13, wherein the end system has multiple accounts thereon, wherein the step of receiving a connection request from a user includes the step of receiving a connection request having an account ID hint included therewith, and wherein the step of performing main mode (MM) authentication of the connection request via Internet key exchange (IKE) protocol includes the step of performing MM authentication of the connection request via IKE based on an aggregate of users listed in a connection policy for one of the accounts identified by the account ID hint.

18. The method of claim 17, wherein the step of performing quick mode (QM) authentication of the communications via IKE based on a rule for the user in the connection policy comprises the step of performing QM authentication based on a rule for the user in the connection policy for one of the accounts identified by the account ID hint.

19. The method of claim 13, further comprising the step of downloading the connection policy from a central administration.

20. The method of claim 13, further comprising the steps of displaying an access control user interface, receiving input from a user of the end system, using the input to define the rules of the connection policy.

21. In a computer system having a graphical user interface including a display and a user interface selection device, a method of displaying and selecting a connection policy on the display comprises the steps of:
retrieving a set of applications processes to which access controls may be defined;
retrieving a listing of authorized users;
displaying the set of applications in association with users who are authorized to access each application defined in the connection policy;
receiving a user input signal indicating a desired modification to the displayed associations and thereafter modifying the connection policy in accordance with the user input; and
displaying the set of applications in association with a modified list of users who are authorized to access each application defined in the modified connection policy.

22. The method of claim 21, wherein the step of receiving a user input indicating a desired modification to the displayed associations comprises the step of receiving a user input indicating a desired addition of a user for a selected application process, further comprising the steps of displaying a list of all authorized users, receiving an authorized user selection input to add a new authorized user association to the selected application process.

23. The method of claim 21, wherein the step of receiving a user input indicating a desired modification to the displayed associations comprises the step of receiving a user input indicating a desired removal of a user for a selected application process, further comprising the steps of displaying a list of all authorized users associated with the selected application process, receiving an authorized user deletion input to remove an authorized user association from the selected application process.

24. The method of claim 2 1, further comprising the steps of displaying a user selectable indicator to secure the computer system, receiving a user input selection of the user selectable indicator, and thereafter securing the computer system in accordance with the connection policy.

25. The method of claim 24, further comprising the steps of displaying a user selectable indicator indicating the that the computer system is secure, receiving a user input selection of the user selectable indicator, and thereafter un-securing the computer system.

26. A computer-readable medium having computer-executable instruction for performing the steps of receiving a connection request from a user, performing main mode (MM) authentication of the connection request via Internet key exchange (IKE) protocol based on an aggregate of users listed in a connection policy, receiving communications from the user, performing quick mode (QM) authentication of the communications via IKE based on a rule for the user in the connection policy, completing the QM authentication when the communications are within a scope of the rule for the user in the connection policy, and enforcing the rule for the user for subsequent communication when the QM completes.

27. The method of claim 26, wherein the step of performing MM authentication comprises the steps of checking a certificate of the connection request against an aggregate listing of all authorized users in the connection policy, and completing MM authentication when the certificate matches an entry in the aggregate listing.

28. The method of claim 26, further comprising the step of transmitting a secure notify message to the user when the communications attempt to exceed the rule for the user in the connection policy.

29. The method of claim 26, wherein the step of enforcing the rule for the user for subsequent communication comprises the steps of enabling IPSec on a socket for the communication, and forcing the socket to be bound in exclusive mode.

30. The method of claim 26, wherein the end system has multiple accounts thereon, wherein the step of receiving a connection request from a user includes the step of receiving a connection request having an account ID hint included therewith, and wherein the step of performing main mode (MM) authentication of the connection request via Internet key exchange (IKE) protocol includes the step of performing MM authentication of the connection request via IKE based on an aggregate of users listed in a connection policy for one of the accounts identified by the account ID hint.

31. The method of claim 30, wherein the step of performing quick mode (QM) authentication of the communications via IKE based on a rule for the user in the connection policy comprises the step of performing QM authentication based on a rule for the user in the connection policy for one of the accounts identified by the account ID hint.

32. The method of claim 26, further comprising the step of downloading the connection policy from a central administration.

33. The method of claim 26, further comprising the steps of displaying an access control user interface, receiving input from a user of the end system, using the input to define the rules of the connection policy.
